(19) United States
(12) Patent Application Publication
(10) Pub. No.: US 2007/0040787 A1
(43) Pub. Date: Feb. 22, 2007

(54) A Modular Graphics Stack

(75) Inventor: Nakshatra Saha, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS, INC., Dallas, TX (US)

(21) Appl. No.: 11/465,279

(22) Filed: Aug. 17, 2006

Related U.S. Application Data
(60) Provisional application No. 60/709,370, filed on Aug. 17, 2005.
(60) Provisional application No. 60/709,335, filed on Aug. 19, 2005.

(51) Int. Cl. G09G 3/36

(52) U.S. Cl. 345/98

(57) ABSTRACT

A system is provided that includes a Liquid Crystal Display (LCD) panel and an LCD controller coupled to the LCD panel. The system also includes a processor coupled to the LCD controller and a memory coupled to the processor. The memory stores a modular graphics stack that provides images and configuration parameters to the LCD controller. The modular graphics stack has a window manager layer, a display driver layer, and an LCD controller hardware abstraction layer (HAL).

### CROSS-REFERENCE TO RELATED APPLICATIONS

This application is a non-provisional application claiming priority to U.S. Pat. App. Ser. No. 60/709,370, entitled “A Method of Supporting Video Data for IP Video Phones”, filed on Aug. 17, 2005, and U.S. Pat. App. Ser. No. 60/709,335, entitled “A Graphics Stack for IP Phones”, filed on Aug. 17, 2005. The above-referenced applications are incorporated herein by reference. This application is related to U.S. Pat. App. Ser. No. ______ entitled “A Modular Graphics Stack With Video Support” filed on Aug. 17, 2006. The above related application is incorporated herein by reference.

### FIELD OF THE INVENTION

The present disclosure is directed to devices having a Liquid Crystal Display (LCD) panel or other display, and more particularly, but not by way of limitation, to Internet Protocol (IP) phones or handheld devices having an LCD panel.

### BACKGROUND

A Liquid Crystal Display (LCD) panel or other display is a common feature for many desktop and handheld devices. These devices are able to display text, shapes, pictures, video, or other objects on the LCD panel based on software/firmware referred to herein as a “graphics stack”. Some graphics stacks support many features but are undesirable for applications in which memory, data bandwidth and/or processing power are limited. Some graphics stacks undesirably restrict customization of features. Some graphics stacks function well with a particular operating system (OS) but not other operating systems.

### SUMMARY

In at least some embodiments, a system comprises a Liquid Crystal Display (LCD) panel and a LCD controller coupled to the LCD panel. The system further comprises a processor coupled to the LCD controller and a memory coupled to the processor. The memory stores a modular graphics stack that provides images and configuration parameters to the LCD controller. The modular graphics stack has a window manager layer, a display driver layer, and an LCD controller hardware abstraction layer (HAL).

In at least some embodiments, a method comprises providing a modular graphics stack having a window manager, a display driver, and a Liquid Crystal Display (LCD) controller hardware abstraction layer (HAL). The method further comprises selectively disabling the window manager.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 shows a device in accordance with embodiments of the disclosure;

FIG. 2 illustrates a graphics stack in accordance with embodiments of the disclosure; and

FIG. 3 illustrates a method in accordance with embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Also, the term “graphics stack” is intended to mean software/firmware that interfaces an operating system or other application with a graphics controller to display text, shapes, pictures, video, or other objects on a graphic user interface such as a Liquid Crystal Display (LCD).

### DETAILED DESCRIPTION

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the disclosure implement a modular graphics stack having three layers which support predetermined functions. The top layer (referred to herein as a “window manager”) provides tools that enable a user/application to update objects displayed on a screen. The middle layer (referred to herein as a “display driver”) maintains two “frame” buffers and a “palette buffer” which can be “flushed” to a screen. As used herein, a “flush” means that the content of a buffer is provided (e.g., via Direct Memory Access) to a panel/display for viewing. Without a flush, modifications to the content of a buffer cannot be viewed on a panel/display. The bottom layer (referred to herein as a “Liquid Crystal Display (LCD) Controller Hardware Abstraction Layer (HAL)”) communicates directly with an LCD controller based on commands from the display driver.

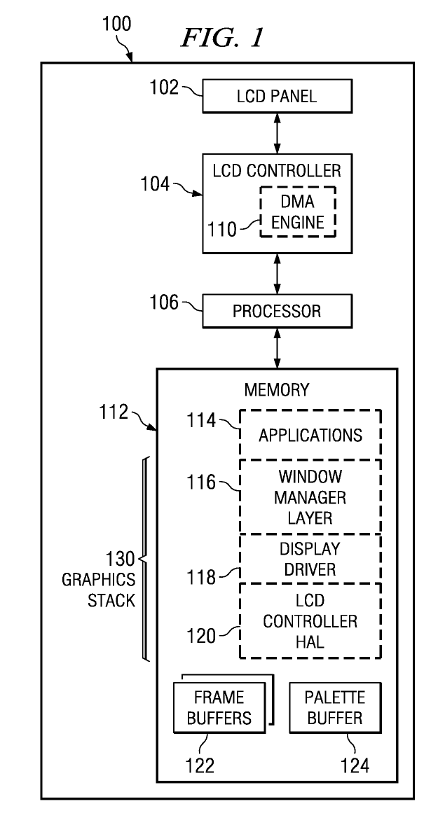

FIG. 1 shows a device 100 in accordance with embodiments of the disclosure. As shown in FIG. 1, the device 100 comprises an LCD panel 102 coupled to a LCD controller 104. The LCD panel 102 can be selected from a variety of commercially available LCD panels now known or later developed. For example, LCD panels varying in size, shape, contrast, resolution, color capabilities (color or monochrome), could be employed as the LCD panel 102. Other display technologies now know or later developed could alternatively be used. In at least some embodiments, the LCD controller 104 controls the operation of the LCD panel 102 based on parameters such as the size of the LCD screen, the pulse width associated with horizontal lines of the LCD panel 102, the pulse width associated with vertical lines of the LCD panel 102, an AC bias, a direct memory access (DMA) burst size, a First-In-First-Out (FIFO) DMA delay request, a number of bits per pixel, an LCD clock, a pixel clock, a monochrome selection or other parameters. In at least some embodiments, the LCD controller 104 comprises a Direct Memory Access (DMA) engine 110 that enables the LCD controller 104 to receive data from a buffer as will later be described. Based on buffer data and parameters such as those described previously, the LCD controller 104 produces an image on the LCD panel 102. If other display technologies were implemented, the parameters for controlling the display would be modified accordingly.

As shown in FIG. 1, the device 100 also comprises a processor 106 coupled to the LCD controller 104 and a memory 112 coupled to the processor 106. Also, in at least some embodiments, the LCD controller 104, the processor 106, and the memory 112 are part of a “system on a chip” (SoC).

In FIG. 1, the memory 112 stores applications 114 for execution by the processor 106. For example, the applications 114 may include an operating system (OS) or another application involved with the content displayed on the LCD panel 102. The memory 112 also stores a graphics stack 130 having a window manager layer 116, a display driver 118 and an LCD controller HAL 120. In at least some embodiments, the window manager layer 116 provides tools that enable a user/application to update features displayed on the LCD panel 102. The display driver 118 maintains two frame buffers 122 and a palette buffer 124 which may be stored in the memory 112. Either of the two frame buffers 122 can be “flushed” (e.g., via DMA) to the LCD controller 104 to update the image on the LCD panel 102. The palette buffer 124 stores color codes that can be indexed by the frame buffers 122 to designate or update colors of an image. The LCD controller HAL 120 communicates directly with the LCD controller 104 based on commands from the display driver 118. Based on data (e.g., frame buffer data) and parameters received from the LCD controller HAL 120, the LCD controller 104 causes the LCD panel 102 to display images such as text, shapes, pictures, video, or other objects.

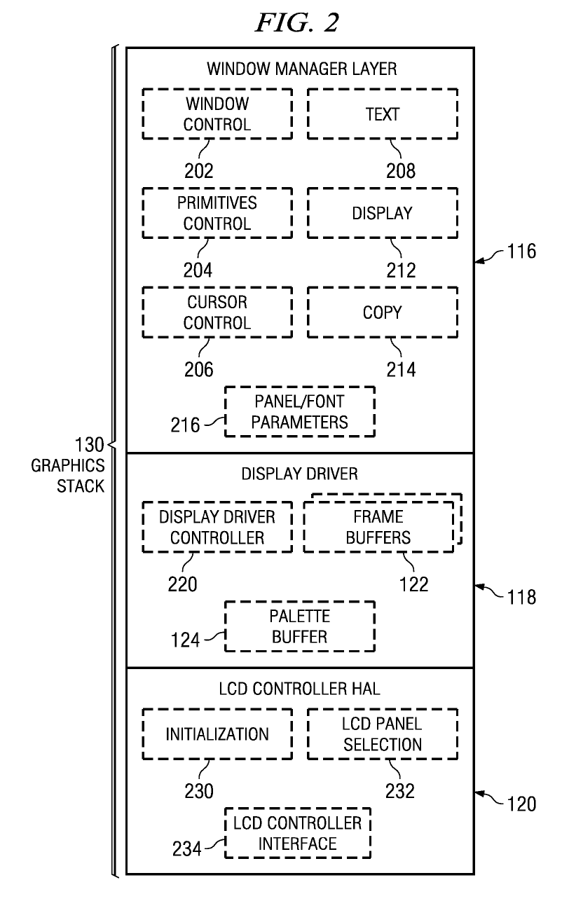

FIG. 2 illustrates a graphics stack 130 in accordance with embodiments of the disclosure. As shown in FIG. 2, the graphics stack 130 comprises the window manager layer 116, the display driver 118 and the LCD controller HAL 120 mentioned previously. In at least some embodiments, the window manager layer 116 comprises a window control tool 202, a primitives control tool 204, a cursor control tool 206, a text tool 208, a display tool 212, a copy tool 214 and panel/font parameters 216 which will later be described. The window manager layer 116 is accessible by a user/application (e.g., an OS) to enable the user/application to modify the image content displayed on the LCD panel 102.

In at least some embodiments, an application 114 may access the window manager layer 116 to draw objects (text or graphics) on the LCD panel 102. When drawing an object, pixels of the LCD panel 102 may be referred to according to a coordinate system. In some embodiments, the top left corner of the LCD panel 102 is referred to as the origin (0,0) coordinate. From the origin, pixels extend horizontally (along the x axis) and vertically (along the y axis). Thus, a pixel referenced as (5, 10) is 5 pixels to the right of the origin and 10 pixels below the origin.

In at least some embodiments, the window manager layer 116 enables various applications 114 to access and modify objects shown on the LCD panel 102 without interfering with each other. For example, the window manager layer 116 enables each application 114 to access and modify one or more windows shown on the LCD panel 102 where each window is defined as a rectangle of a given size and location on the LCD panel 102. In some embodiments, the top left corner of a window is identified as the “anchor” of the window.

When the window manager layer 116 creates a new window, a window identifier is provided to the application that requested the new window. Thereafter, the application can access and modify the window by providing the window identifier and a supported request. Thus, each application can open one or more windows on the LCD panel 102 and gain sole rights to access and modify these windows. Although the window manager layer 116 supports multiple windows, the window manager layer 116 could be used to display a single window on the LCD panel 102 (e.g., for writing text, line-by-line). Although not required, the single window could be size of the LCD panel 102.

In some embodiments, each window behaves as a virtual screen such that no other information regarding the LCD panel 102 or other windows being displayed is needed to modify a given window. For example, pixels within a given window can be referenced from the window's top left corner even though the given window is not at the origin of the LCD panel 102. In other words, if a window anchor is positioned at (5,5) on the LCD panel 102, modifying a pixel referenced as (5, 6) in the window is effectively modifying the pixel at (10,11) on the LCD panel 102.

In addition to supporting multiple windows, the window manager layer 116 also supports overlapping windows, moving windows, disabling/enabling windows, bringing a window to the front, providing a background image and other features. In at least some embodiments, the window manager layer 116 maintains a list of windows descriptors corresponding to windows displayed on the LCD panel 102. The list of window descriptors may be, for example, a linked list where, for every new window that is created, a corresponding window descriptor is created and attached to the end of the list. After a new window is created, information (sometimes referred to as a “handle”) is returned to the application which requested window creation. The handle may be, for example, a base address of the window descriptor. The window's handle can be used to later access and modify the window which corresponds to the handle.

In at least some embodiments, a window descriptor includes configuration and/or runtime state information corresponding to the window associated with the window descriptor. As an example, Table 1 shows a structure for a window descriptor.

TABLE 1

| PARAMETER | PARAMETER | |
|---|---|---|
| TYPE | NAME | COMMENTS |
| Structure | win_desc | Structure definition begins |
| Next Call | win_desc *next | Next window descriptor, updated by |
| | | next call to “create window” |
| | | Application Programming |
| | | Interface (API) |
| Integer | is_disable | Runtime state which; set to disable |
| | | window |
| Integer | is_updated | Runtime state; set to update window |
| Integer | end_off | End odd pixel per byte; for copy |
| | | optimization |
| Integer | int_bytes | Number of bytes per line minus |
| | | end_off; for copy optimization |
| Integer | cu_x | Cursor x coordinate |
| Integer | cu_y | Cursor y coordinate |
| Color Code | fg | Foreground color |
| Color Code | bg | Background color |
| Descriptor | dd_d | Descriptor for passing information to |
| | | display driver |
| Structure Call | WIN_DESC_T | Descriptor reference |

In Table 1, the “cu_x” and “cu_y” parameters designate the location within a window where future writes to the window begin. The cu_x and cu_y parameters can be updated after every write to the window. As needed, an Application Programming Interface (API) can be used to update the cu_x and cu_y parameters to any pixel within a window. The cu_x and cu_y parameters can be reset to zero when a new window is created.

The “is_disabled” and “is_updated” parameters are runtime states of a window and can be used when updating a frame buffer based on the window. For example, if is_disabled=1, the corresponding window is disabled and the frame buffer can be updated to remove the window. If is_updated=1, the corresponding window is updated and the frame buffer can be updated accordingly. The “dd_d” parameter is used to pass information to the display driver (e.g., during a flush operation).

The window descriptors (e.g., WIN_DESC_T) in the linked list are referenced from a master window manager structure (referred to herein as “WINMGR_DESC_T”). In at least some embodiments, WINMGR_DESC_T maintains a runtime state used during a flush operation. Also, WINMGR_DESC_T maintains pointers to the beginning and the end of the linked list. For example, if the descriptor WIN_DESC_T is the only descriptor in the linked list, WINMGR_DESC_T would maintain pointers to the beginning and end of WIN_DESC_T. As new windows are created, descriptors are added to the linked list. As existing windows are deleted, descriptors are removed from the linked list.

In at least some embodiments, WINMGR_DESC_T is created during an initialization process of the window manager layer 116. The initialization process also creates a first window. For example, the first window could be treated as a background or backdrop to be displayed on the LCD panel 102. The background could be an image passed during an API call, any given background color or a combination of a background color and an image.

In at least some embodiments, updating the contents of a window does not automatically update the image displayed on the LCD panel 102. In other words, the graphics stack 130 supports features such as avoiding screen tearing, selectively overlapping windows and updating multiple windows prior to displaying the updates.

Although the window manager layer 116 could overlap windows by simply writing the contents of each window one-by-one from the beginning of the linked list to the end, other processes that update overlapping windows are preferred. For example, if a window is flushed based on a first API call, the window manager layer 116 forwards the flushed window to the display driver 118 and searches the entire linked list for windows that overlap the flushed window. Based on the search, overlapping windows are flushed and non-overlapping windows are not flushed. If a window is flushed based on a second API call, the window manager layer 116 forwards the flushed window to the display driver and searches part of linked list for windows that overlap the flushed window. For example, the window manager layer 116 may search the linked list up to point of the flushed window. Based on the search, overlapping windows are flushed and non-overlapping windows are not flushed. In at least some embodiments, the first API call is a normal window flush operation while the second API call is based on requests such as a request to move a window, a request to bring a window to the front, a request to delete a window, or a request to enable/disable a window. Following the operation of the second API call, the operation of the first API call can be performed.

In at least some embodiments, the window manager layer 116 defines system fonts based on bit-masks that use a two-dimensional array for each of the ASCII characters. The first dimension indexes the ASCII character and the second dimension indexes one line of the bit-mask for a given height of the font (i.e., a given font table is characterized by pre-defined width and height). Whenever a character is written to a window, the bit-mask is written to a particular location starting from the top to the bottom of the character height. In at least some embodiments, the starting location to enter text is the current cursor location. Once text is entered, the cursor moves to the next location and so on. Similar to the creation of ASCII characters, bit-masks could be used to create icons and other objects.

In at least some embodiments, the window manager layer 116 enables new windows to be placed on top of existing windows for the purpose of modifying separate portions of a window at different times (e.g., more frequently or less frequently). In some cases, the user is unable to detect that there are different windows being updated rather than a single window being updated. For example, a clock window could include separate windows for hours, minutes, and seconds so that the entire window need not be updated every second (only the “seconds” window is updated every second). In such case, the user is preferably unable to detect that only the “seconds” window is being updated. In this manner, the amount of processing and system data bandwidth needed to update an image can be significantly reduced.

As previously mentioned, the window manager layer 116 comprises a window control tool 202, a primitives control tool 204, a cursor control tool 206, a text tool 208, a display tool 212, a copy tool 214 and panel/font parameters 216. These tools and parameters are related to APIs or routines supported by the window manager layer 116

In at least some embodiments, the window control tool 202 supports a window manager initialization routine, a create window routine, a delete window routine, a move window routine, an enable/disable window routine, and a touch window routine. For example, the window manager initialization routine initializes the window manager layer 116 and creates a backdrop window. The backdrop can be either an image or a backdrop color or both. The initialization routine can be called by an API such as WINMGR_STATUS winmgr_init (char *img, COLOR_CODE_T backdrop_color).

The create window routine creates a window based on input parameters such as anchor coordinates, window height, window width, background color and foreground color. The create window routine returns a handle (“hdl”) for future accesses to the created window. The create window routine can be called by an API such as WINMGR_STATUS winmgr_win_create (UINT32 x0, UINT32 y0, UINT32 width, UINT32 height, COLOR_CODE_T bg, COLOR_CODE_T fg, void **hdl).

The delete window routine deletes a window based on an input parameter (e.g., a handle) that identifies the window to be deleted. The delete window routine can be called by an API such as WINMGR_STATUS winmgr_win_del (void *hdl).

The move window routine moves a window based on input parameters that define the window to be moved and the new location for the window. If the new coordinates for the window fall outside the coordinate system for the LCD panel 102, the move window routine returns a failure. The move window routine can be called by an API such as WINMGR_STATUS winmgr_win_mv (void *hdl, UINT32 x0, UINT32 y0).

The enable/disable window routine temporarily disables a window based on an input parameter (e.g., a handle) that identifies the window to be enabled/disabled and an input parameter than indicates whether the window is enabled or disabled. If the window is disabled, the window exists (in memory) but is not displayed on the LCD panel 102. If a disabled window is later enabled, the window is displayed on the LCD panel 102. The enable/disable window routine can be called by an API such as WINMGR_STATUS winmgr_win_endis (void *hdl, BOOL enable_disable).

The touch window routine positions a window at the front of the LCD panel 102 based on an input parameter (e.g., a handle) that identifies the window to be brought to the front. The touch window routine can be called by an API such as WINMGR_STATUS winmgr_win_touch (void *hdl).

In at least some embodiments, the primitives control tool 204 supports a draw rectangle routine, a draw pixel routine, a draw arc routine, and a draw line routine. The draw rectangle routine draws a rectangle on the LCD panel 102 based on input parameters such as the rectangle's anchor, the width, the height, and a fill color. The draw rectangle routine can be called by an API such as WINMGR_STATUS winmgr_draw_rectangle (void *hdl, UINT32 x1, UINT32 y1, UINT32 width, UINT32 height, UINT32 is fill).

The draw pixel routine draws (darkens) a pixel based on input parameters such as the pixel coordinate and pixel color. In some embodiments, the pixel color is set as the foreground color of a window. The draw pixel routine can be called by an API such as WINMGR_STATUS winmgr_draw_pixel (void *hdl, UINT32 x, UINT32 y).

The draw arc routine draws an arc based on input parameters such as three coordinate positions and an arc color. In some embodiments, the arc color is set as the foreground color of a window. The draw arc routine can be called by an API such as WINMGR_STATUS winmgr_draw_arc (void *hdl, UINT32 x1, UINT32 y1, UINT32 x2, UINT32 y2, UINT32 x3, UINT32 y3).

The draw line routine draws a line based on input parameters such as two coordinate positions and a line color. In some embodiments, the line color is set as the foreground color of a window. The draw line routine can be called by an API such as WINMGR_STATUS winmgr_draw_line (void *hdl, UINT32 x1, UINT32 y1, UINT32 x2, UINT32 y2).

The cursor control tool 206 supports a cursor control routine that points a cursor to a new location within a window. For example, pointing the cursor to a new location within a window enables text to be written at the new location. The cursor control routine can be called by an API such as WINMGR_STATUS winmgr_set_cursor (void *hdl, UINT32 x, UINT32 y).

The text tool 208 supports a text entry routine that prints a character at the location indicated by the cursor. The text can be entered using the window's foreground color. Also, the cursor location is updated as text is entered (allowing strings of text to be entered). The text entry routine can be called by an API such as WINMGR_STATUS winmgr_print_ch (void *hdl, UINT8 idx), where “idx” is the ASCII equivalent of a text character. The text tool 208 also supports a print routine which provides a wrapper on top of the text entry routine. The print routine can be called by an API such as WINMGR_STATUS winmgr_print_str (void *hdl, char *str).

The display tool 212 supports a display routine that flushes a given window to the LCD panel 102. The display routine can be called by an API such as WINMGR_STATUS winmgr_win_flush (void *hdl). In at least some embodiments, the display routine does not flush data directly to the LCD panel 102. For example, the data from the window manager layer 116 may be flushed to one of the frame buffers 122 maintained by the display driver 118 prior to displaying the image on the LCD panel 102. In this manner, the display driver 118 is able to consider multiple updates, window overlapping or other issues that affect the content of the LCD panel 102 before the LCD panel 102 is updated.

The copy tool 214 supports a copy routine that copies any image (e.g., bitmap images) with a defined width and height to a given location in a window. The copy routine can be called by an API such as WINMGR_STATUS winmgr_blt_img (void *hdl, char *img, UINT32 x1, UINT32 y1, UINT32 width, UINT32 height).

The panel/font parameters 216 support “get” routines and “set” routines to access and control LCD parameters such as width, height, bits per pixel, font parameters (width and height) as well as window parameters such as foreground and background color. The get and set routines can be called by an API such as WINMGR_STATUS winmgr_ioctl (void *hdl, COMMAND_T cmd, void *val).

As shown in FIG. 2, the display driver 118 is positioned between the window manager layer 116 and the LCD controller HAL 120. In other words, data and commands from the window manager layer 116 are not provided directly to the LCD controller HAL 118. In this manner, the display driver 118 is able to update and manipulate images (e.g., windows) to be displayed on the LCD panel 102 before providing the images to the LCD panel 102. As shown in FIG. 2, the display driver 118 maintains two frame buffers 122 and a palette buffer 124. The display driver 118 also comprises a display driver controller 220 which supports operations such as double buffering, color rotation and flush operations.

In at least some embodiments, the LCD controller 104 continuously receives data from one of the frame buffers 122 and provides the data to the LCD panel 102. For example, the DMA engine 110 can be used to DMA data from one of the frame buffers 122 to the LCD controller 104, which then displays the data on the LCD panel 102. If a data from a single buffer is being read and updated simultaneously, a “tearing” effect or image jittering may occur. To prevent the tearing effect, both frame buffers 122 are originally in sync with respect to content, but only one provides data to the LCD panel 102. The free frame buffer is used by the display driver 118 to receive write requests by the window manager layer 116. Thus, if a flush operation is requested by the window manager layer 116, the free frame buffer receives the new image while the other buffer provides data to the LCD panel 102.

In some embodiments, the DMA activity with the current frame buffer can be stopped to enable the newly updated free frame buffer to be attached to the DMA engine 110 for flushing the new content to the LCD panel 102. Subsequently, the contents of the newly updated frame buffer is provided to the other frame buffer (e.g., via DMA) so that both frame buffers are in sync again. The process is then repeated with one frame buffer providing data to the LCD panel 102 while the free buffer is available for image updates from the window manager layer 116.

In at least some embodiments, a color shade on the LCD panel 102 can be changed while the rest of the image remains unchanged. This process is referred to herein as a “color rotation”. To accomplish the color rotation, at least one of the frame buffers 122 is maintained while the palette buffer 124 is updated to change the color codes as desired. With the palette buffer 124 updated, the LCD controller 104 is able to display the same image with updated colors on the LCD panel 102.

In at least some embodiments, the display driver controller 220 supports routines such as a display driver initialization routine, a frame buffer update routine, a frame buffer flush routine, a color rotation routine, and an update LCD panel parameters routine. The display driver initialization routine initializes the display driver 118 including the frame buffers 122 and the palette buffer 124. In some embodiments, the display driver initialization routine is performed during a system initialization. Also, the display driver initialization routine may provide the option of having a system “splash” screen flushed to the LCD panel 102. The display driver initialization routine can be called by an API such as DISPDRV_STATUS dispdrv_init (void).

The frame buffer update routine is used by the window manager layer 116 to update the window contents of the frame buffers 122. In some embodiments, the frame buffer update routine includes a structure that is used to map a window to the coordinates of the LCD panel 102. The frame buffer update routine also may include information that optimizes the write operation to the frame buffers 122. The frame buffer update routine can be called by an API such as DISPDRV_STATUS dispdrv_update_databuf (DD_DESC_T *dd_d), where DD_DESC_T refers to a window descriptor.

The frame buffer flush routine is used by the window manager layer 116 to flush the current updated frame buffer 122 to the LCD controller 104. The frame buffer flush routine can be called by an API such as DISPDRV_STATUS dispdrv_databuf_flush (void).

The color rotation routine supports a color rotation process by modifying the palette buffer 124 and flushing the contents of the palette buffer 124 to the LCD controller 104. The color rotation routine can be called by an API such as void LCD_fill_palette (char *palette).

The update LCD panel parameters routine supports various “set” and “get” commands to update LCD panel parameters such as width, height, bits per pixel, or contrast. The update LCD panel parameters routine can be called by an API such as DISPDRV_STATUS dispdrv_ioctl (DISPDRV_CMT_T cmd, void *val).

As shown in FIG. 2, the LCD controller HAL 120 is a functional layer positioned below the display driver 118. In at least some embodiments, the LCD controller HAL 120 comprises an LCD controller interface 234 that interfaces the display driver 118 with the LCD controller 104. For example, the LCD controller interface 234 may receive data and instructions from the display driver 118 and forward the data and instructions to the LCD controller 104. The LCD controller HAL 120 also comprises a HAL initialization block 230 and an LCD panel selection tool 232. The HAL initialization block 230 supports initialization of the LCD controller HAL 120. The LCD panel selection tool 232 supports a database of a wide range of possible LCD panels and their respective LCD panel parameters. During initialization, the database is accessed and a set of PCD panel parameters is selected and forwarded to the LCD controller 104. Using the database, the LCD panel selection tool 232 accesses information such as LCD panel types (e.g., quarter video graphics array (QVGA)), a maximum bits per pixel for each LCD panel, a minimum bits per pixel for each LCD panel, color options for each LCD panel or monochrome options for each LCD panel. The above information can be maintained in defined structures or code (i.e., each LCD panel with corresponding LCD panel parameters are grouped and defined by a callable structure such as “DISPLAY_PANNEL_T”).

In at least some embodiments, the display driver 118 provides LCD panel configuration parameters to the LCD controller HAL 120 which forwards the configuration parameters to the LCD controller 104. The configuration parameters may include, but are not limited to, a horizontal starting point, horizontal ending point, a horizontal sync pulse width, a vertical starting point, a vertical ending point, a vertical sync pulse width, an AC bias pin frequency, an AC bias pin interrupt, a DMA burst size, bits per pixel, a FIFO DMA delay request, an LCD clock, a pixel clock and a monochrome selection. These configuration parameters can be maintained in a defined structure or code (i.e., the configuration parameters are grouped and defined by a callable structure such as “LCD_CNTRL_CONFIG_T”). In some embodiments, the structure (e.g., LCD_CNTRL_CONFIG_T) that maintains the configuration parameters may reference the structure (e.g., DISPLAY_PANNEL_T) that maintains LCD panel parameters.

In at least some embodiments, the LCD controller HAL 120 supports routines such as a HAL initialization routine, a HAL bliting routine, an interrupt handler routine, and a parameter update routine. The HAL initialization routine configures the LCD controller 104 based on configuration parameters provided by a structure. Once the HAL initialization routine has been performed, the LCD controller 104 is able to receive data from the frame buffer 122. The HAL initialization routine can be called by an API such as LCD_HAL_STATUS lcd_hal_init (LCD_CNTRL_CONFIG_T *cfg).

The HAL bliting routine flushes a frame buffer 122 or the palette buffer 124 to the LCD controller 104. In some embodiments, the HAL bliting routine selects whether the frame buffer or the palette buffer should be flushed based on an input parameter (e.g., “p_buf”). The HAL bliting routine can be called by an API such as LCD_HAL_STATUS LCD_hal_blit (RASTER_LOAD_MODE_T load_mode, char *p_buf).

The interrupt handler routine is used, for example, when the HAL bliting routine is complete or if an error occurs during the transfer of the frame buffer image or the palette buffer image. The interrupt handler routine can be called by an API such as LCD_HAL_STATUS LCD_hal_intrpt (UINT32 *mask).

The parameter update routine provides set and get commands for updating parameters such as an AC bias frequency or other LCD parameters. The parameter update routine can be called by an API such as LCD_HAL_STATUS LCD_hal_ioctl (LCD_CMD_T cmd, void *val).

There are several potential advantages provided by the graphics stack 130 discussed in FIGS. 1 and 2. By dividing the graphics stack 130 into three different functional layers, applications (e.g., operating systems) are able to selectively utilize the functions of each layer. For example, a first set of operating systems (e.g., “VxWorks”) may lack a graphics stack that supports functions such as those described for the window manager layer 116, the display driver 118 and the LCD controller HAL 120. Thus, the first set of operating systems may utilize the window manager layer 116, the display driver 118 and the LCD controller HAL 120 fully or as needed. Meanwhile, a second set of operating systems (e.g., “WinCE” and “Linux”) may each have a graphics stack which supports functions such as those described for the window manager layer 116. Thus, the second set of operating systems do not utilize (or reduce utilization of) the window manager layer 116 but use the display driver 118 (either whole or reduced functionality) and the LCD controller HAL 120.

In at least some embodiments, the functions supported by graphics stack 130 are intended for mobile devices having limited memory and processing capabilities. Thus, the size and operation of the graphics stack 130 involves a small memory “footprint” and reduces processing/data overhead compared to other graphics stacks. Also, the graphics stack 130 is customizable.

As described herein, the graphics stack 130 is simplistic and highly flexible. In some embodiments, the graphics stack 130 provides a memory footprint in the KB range (e.g., between 10-100 KB) which favorably compares to more complicated graphics stacks having memory footprints in the MB range. To increase the functionality of the graphics stack 130 new tools/functions could be added to the graphics stack 130 based on existing routines. For example, a routine that draws a rectangle with rounded corners could be provided based on the draw rectangle routine and the draw arc routine.

If needed, the graphics stack 130 could be distilled to occupy an even smaller memory footprint. For example, the graphics stack 130 could implement a single frame buffer instead of two frame buffers. Also, tools/functions that are not needed for a particular device or application could be removed.

The modular graphics stack 130 described herein is compatible with advanced applications and simple applications. For example, embedded systems having a display, calculators, Internet Protocol (IP) phones, Wireless Local Area Network (WLAN) phones, or cellular phones could each use the graphics stack 130 to display images on an LCD panel. The graphics stack 130 could also be implemented with a laptop computer or desktop computer.

In some embodiments, the graphics capabilities of the device 100 are secondary to other capabilities (e.g., voice processing, communication or other capabilities). Using the graphics stack 130 in devices where graphics capabilities are secondary helps ensure that sufficient memory and processing resources are available for the primary (higher priority) capabilities of the device 100. For example, in an IP phone, voice processing has higher priority than graphics. Accordingly, the graphics stack 130 helps ensure that sufficient processing and system data bandwidth is available for voice processing while supporting graphics as well.

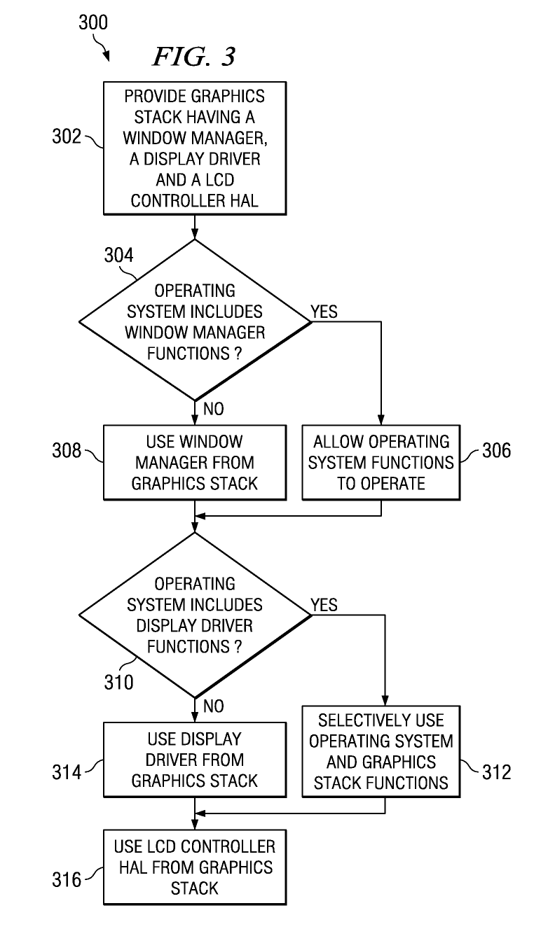

FIG. 3 illustrates a method 300 in accordance with embodiments of the invention. As shown in FIG. 3, the method 300 comprises providing a graphics stack having a window manager, a display driver and a LCD controller HAL (block 302). If an operating system of a device includes window manager functions (determination block 304), the method 300 allows the window manager functions of the operating system to operate (block 306). In other words, the window manager of the graphics stack is not used or is partially used. If the operating system of the device does not include window manager functions (determination block 304), the window manager of the graphics stack is used (block 308).

If the operating system of the device includes display driver functions (determination block 310), then display driver functions of the operating system and the graphics stack are selectively used (block 312). For example, the operating system and the graphics stack can work together to provide a double buffering process that supports display driver functions such as avoiding tears and jitters on the LCD panel 102, allowing color rotations, or other functions. If the operating system of the device does not include display driver functions (determination block 310), the display driver of the graphics stack is used (block 314). At block 316, the LCD controller HAL from the graphics stack is used.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system, comprising:
a Liquid Crystal Display (LCD) panel;
an LCD controller coupled to the LCD panel;
a processor coupled to the LCD controller; and
a memory coupled to the processor, wherein the memory stores a modular graphics stack that provides images and configuration parameters to the LCD controller,
wherein the modular graphics stack has a window manager layer, a display driver layer, and an LCD controller hardware abstraction layer (HAL).

2. The system of claim 1 wherein the window manager layer comprises a window control tool that provides a routine for creating windows to be displayed on the LCD panel.

3. The system of claim 2 wherein the window control tool provides routines for deleting windows, moving windows, enabling/disabling windows, and selectively displaying a window in front of other existing windows.

4. The system of claim 1 wherein the window manager layer comprises,
a primitives tool for drawing rectangles, lines, and pixels;
a cursor tool for designating a cursor location within a window;
a text tool for entering text in a window; and
a copy tool for copy images within a designated area of a window.

5. The system of claim 1 wherein the window manager layer provides access and control of parameters that adjust a LCD panel width, an LCD panel height, bits per pixel, font size, font style, background color of a window and foreground color of a window.

6. The system of claim 1 wherein the display driver maintains a first buffer and a second buffer for storing images to be displayed on the LCD panel.

7. The system of claim 6 wherein an image stored in the second buffer is updated while an image in the first buffer is flushed to the LCD controller.

8. The system of claim 7 further comprising a Direct Memory Access (DMA) engine coupled to the memory, wherein a DMA operation that attaches the first buffer to the LCD controller stops while the second buffer transfers an updated image to the first buffer.

9. The system of claim 1 wherein the display driver overlaps windows by reviewing all window descriptors in a linked list and flushing only windows that overlap a predetermined window.

10. The system of claim 1 wherein the display driver overlaps windows by reviewing window descriptors in a linked list up to a predetermined window in the linked list and wherein only windows that overlap the predetermined window are flushed to the LCD controller.

11. The system of claim 1 wherein the display driver updates at least one smaller window within a larger window and wherein the at least one smaller window is updated more frequently than the larger window.

12. The system of claim 1 wherein the display driver supports updating a color displayed on the LCD panel while maintaining an image displayed on the LCD panel.

13. The system of claim 1 wherein the LCD Controller HAL maintains a database of LCD panel types and LCD panel parameters.

14. The system of claim 1 wherein the memory further stores an application and wherein the window manager layer is selectively disabled based on graphics stack functions supported by the application.

15. The system of claim 1 wherein the memory further stores an operating system and wherein portions of the window manager layer are selectively disabled based on graphics stack functions supported by the operating system.

16. A method, comprising:
providing a modular graphics stack having a window manager, a display driver, and a hardware abstraction layer (HAL);
selectively disabling the window manager.

17. The method of claim 16 further comprising,
writing an image to a first buffer and a second buffer maintained by the display driver; and
updating the image in the second buffer while the image of the first buffer is transferred to a display.

18. The method of claim 16 further comprising,
storing an image in a frame buffer and storing color codes in a palette buffer, wherein the frame buffer indexes the colors codes stored in the palette buffer; and
updating the color codes in the palette buffer to change colors associated with the image stored in the frame buffer.

19. The method of claim 16 further comprising creating a master window manager structure having at least one window descriptor, wherein the master window manager structure supports routines for overlapping windows, moving windows, disabling/enabling windows, and placing a window in front of other windows.

20. The method of claim 19 further comprising, during initialization of the master window manager structure, creating a background window as the first window of the master window manager structure, wherein the background window corresponds to at least one of an image and a background color.

21. The method of claim 16 further comprising optimizing processing and system data bandwidth by updating at least one smaller window within a larger window, wherein the at least one smaller window is updated more frequently than the larger window.
